(19) United States
(12) Patent Application Publication
(10) Pub. No.: US 2026/0049210 A1
(43) Pub. Date: Feb. 19, 2026

(54) CONTROLLED-RHEOLOGY MIXED-PLASTICS POLYPROPYLENE-BASED BLENDS

(71) Applicant: BOREALIS AG, Vienna (AT)

(72) Inventors: Yi Liu, Linz (AT); Susanne Margarete Kahlen, Linz (AT); Jingbo Wang, Linz (AT); Peter Denifl, Linz (AT); Jörg Fischer, Linz (AT); Markus Gall, Linz (AT); Moritz Mager, Linz (AT); Reinhold W. Lang, Linz (AT); Sandra Czaker, Linz (AT)

(21) Appl. No.: 19/104,281

(22) PCT Filed: Aug. 23, 2023
(86) PCT No.: PCT/EP2023/073135

§ 371 Date: Feb. 17, 2025

(30) Foreign Application Priority Data
Aug. 24, 2022 (EP) 22191876.6

(51) Int. Cl. C08L 23/12; C08J 3/20; C08K 5/06; C08K 5/3435

(52) U.S. Cl. CPC C08L 23/12; C08J 3/203; C08K 5/06; C08K 5/3435; C08J 2323/12; C08J 2423/06; C08J 2423/12; C08L 2205/025; C08L 2207/20

(57) ABSTRACT

The present invention relates to a controlled-rheology polypropylene composition originating from a polypropylene composition comprising a mixed-plastics polypropylene based blend and having a melt flow rate MFR₂ of at least 10 g/10 min and a volatile organic compounds (VOC) emission in the GC-MS time interval of 3.0 to 8.5 minutes of not more than 2.8 μg/g, a process for producing such a controlled-rheology polypropylene composition, an article comprising such a controlled-rheology polypropylene composition and the use of such a controlled-rheology polypropylene composition for the production of an article comprising a mixed-plastics polypropylene based blend.

The present invention relates to a controlled-rheology polypropylene composition originating from a polypropylene composition comprising a mixed-plastics polypropylene based blend and having a melt flow rate MFR₂ of at least 10 g/10 min, and a volatile organic compounds (VOC) emission in the GC-MS time interval of 3.0 to 8.5 minutes of not more than 2.8 μg/g, a process for producing such a controlled-rheology polypropylene composition, an article comprising such a controlled-rheology polypropylene composition and the use of such a controlled-rheology polypropylene composition for the production of an article comprising a mixed-plastics polypropylene based blend.

### TECHNICAL BACKGROUND

With their inherent versatility, plastics play crucial roles in a sustainable and resource-efficient economy. However, as more and more plastic has been created and used in a mode of linear economy, plastic waste is nowadays considered a serious environmental and social problem. For that, it is important to form a circular economy that brings plastic waste back to a second life, i.e., to recycle it. This not only avoids leaving plastic waste in the environment but also recovers its value. The European Commission confirmed in 2017 that it would focus on plastics production and use. The EU goals are that 1) by 2025 at least 50% of all plastics packaging in the EU should be recycled and 2) by 2030 all plastic packaging placed in the EU market is reusable or easily recycled. This pushes the brand owners and plastic converters to pursue solutions with recyclate or virgin/recyclate blends. On 1 Jan. 2021, EU introduced a new levy on non-recycled plastic packaging, which is calculated on the weight of non-recycled plastic packaging at €0.80/kg

It is therefore urgently needed to find ways of recycling plastic waste. However, recycled plastics are normally inferior to virgin plastics in their quality due to degradation, contamination and mixing of different plastics. On the other hand, unlike the reactor grades, for which we can control the processability and mechanical performance by adjusting the polymerization conditions, the processability and mechanical performance of recyclates largely depend on the feedstock and process. Typically, unmodified recyclates are available only in a rather narrow range of MFR values (i.e. melt viscosities). Blending them with virgin polymers or treating them with peroxides are the common practice to tune their properties, in particular in the case of polyolefins.

The use of free-radical formers for modifying the melt viscosity (rheology) of polyolefins is a generally known method for virgin polyolefins. Whether it results in a lowering of the molecular weight (degradation) or an increase in the molecular weight (cross linking) depends primarily on the chemical structure of the polyolefin. The reaction of a polymer of the polypropylene (PP) type with a free-radical former during a polymer-processing process generally results in the degradation of the polymer, whereas polymers of the polyethylene type tend to crosslink.

The controlled degradation of polypropylene to give a product having a lower molecular weight and a narrower molecular weight distribution is a commercially important process for producing ‘controlled rheology’ polypropylene.

Known degradation processes proceed either thermally, in particular at temperatures above 280° C., or in the presence of free-radical generators. In process technology, the free-radical induced process is carried out in extruders or injection-moulding machines at temperatures above 180° C. Free-radical generators used are organic peroxides, which are added during the processing step in diluted form (PP masterbatch, diluted in oil, stabilized on inorganic supports) or directly as a liquid. Under the given processing conditions, the peroxide disintegrates into free radicals, which initiate the chain cleavage reactions and form polymers having the desired rheological properties (melt viscosities). The degradation of a polypropylene to form a product having a lower molecular weight (higher melt flow rate (MFR)) and most importantly, a lower melt viscosity is generally referred to as a viscosity-breaking or vis-breaking process. Polypropylenes that have been rheology-modified in this way are generally known as ‘controlled-rheology’ polypropylenes.

Peroxides, though widely used to modify rheological properties of polyolefins, have their drawbacks, e.g., increasing emissions, strict safety regulations have to be followed during storage, handling and transportation. Many peroxides are subject to specific regulatory measures, e.g. registration under GHS/CLP and specific exposition limits might apply in various countries, etc (REGULATION (EC) No 1272/2008 OF THE EUROPEAN PARLIAMENT AND OF THE COUNCIL on classification, labelling and packaging of substances and mixtures, amending and repealing Directives 67/548/EEC and 1999/45/EC, and amending Regulation (EC) No 1907/2006).

Controlled rheology polypropylene grades are mainly used for film, fibre applications and injection-moulding applications in which low melt viscosities are a prerequisite for economical processing. A wide range of melt viscosities or molecular weights is nowadays required in process technology.

Thus, there is a need for producing a controlled-rheology polypropylene composition which originates from a polypropylene composition comprising a mixed-plastics polypropylene based blend, which does not show the drawbacks of peroxide modified polypropylene compositions.

The present invention provides a rheology controlled polypropylene composition originating from a polypropylene composition comprising a mixed-plastics polypropylene based blend and having a melt flow rate MFR₂ of at least 10 g/10 min, which shows surprisingly low total volatile organic compounds (VOC) contents and specifically low volatile organic compounds (VOC) emissions in the time interval of 3.0 to 8.5 minutes as obtained from GC-MS.

### SUMMARY OF THE INVENTION

The present invention relates to a controlled-rheology polypropylene composition (CR-PP) originating from a polypropylene composition (PP) comprising a mixed-plastics polypropylene based blend,
wherein the controlled-rheology polypropylene composition has
a melt flow rate MFR₂ of at least 10 g/10 min, such as in the range of from 10 to 250 g/10 min, preferably from 15 to 225 g/10 min, more preferably from 25 to 200 g/10 min, still more preferably from 40 to 175 g/10 min, most preferably from 65 to 150 g/10 min, determined according to ISO 1133-1:2011 at 230° C. and 2.16 kg, wherein the ratio of the melt flow rate of the controlled-rheology polypropylene composition MFR₂ (CR-PP) to the melt flow rate of the original polypropylene composition MFR₂ (PP) is in the range of from 1.5 to 30.0; and
a volatile organic compounds (VOC) emission in the GC-MS time interval of 3.0 to 8.5 minutes of not more than 2.8 μg/g, such as in the range of from 1.5 to 2.7 μg/g, preferably from 1.7 to 2.6 μg/g, more preferably from 2.0 to 2.5 μg/g, determined by GC-MS.

Further, the present invention relates to a process for producing the controlled-rheology polypropylene composition as described above or below comprising the steps of:
Providing a polypropylene composition comprising a mixed-plastics polypropylene based blend;
Mixing the polypropylene composition with a non-peroxide rheology control agent;
Compounding the polypropylene composition with the non-peroxide rheology control agent at a maximum temperature of less than 250° C., preferably in the range of from 160 to 230° C., more preferably in the range of from 200 to 220° C.

Still further, the present invention relates to an article comprising the controlled-rheology polypropylene composition as described above or below.

Furthermore, the present invention relates to the use of the controlled-rheology polypropylene composition as described above or below for the production of an article comprising a mixed-plastics polypropylene based blend.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below. Unless clearly indicated otherwise, use of the terms “a,” “an,” and the like refers to one or more.

Mixed plastics is defined as the presence of low amounts of compounds usually not found in virgin polypropylene blends such as polystyrenes, polyamides, polyesters, wood, paper, limonene, aldehydes, ketones, fatty acids, metals, other inorganic substances like chalk or talc and/or long term decomposition products of stabilizers. Virgin polypropylene blends denote blends as directly originating from the production process without intermediate use.

As a matter of definition “mixed plastics” can be equated with detectable amounts of polystyrene and/or polyamide and/or limonene and/or fatty acids.

Mixed plastics thereby can originate from both post-consumer waste and industrial waste, as opposed to virgin polymers. Post-consumer waste refers to objects having completed at least a first use cycle (or life cycle), i.e. having already served their first purpose. In contrast to that, industrial waste refers to start-up lumps, flushing materials, and manufacturing scrap, respectively conversion scrap, which does not normally reach a consumer.

A polymer blend is a mixture of two or more polymeric components. In general, the blend can be prepared by mixing the two or more polymeric components. A suitable mixing procedure known in the art is post-polymerization blending.

Post-polymerization blending can be dry blending of polymeric components such as polymer powders and/or compounded polymer pellets or melt blending by melt mixing the polymeric components.

A polypropylene means a polymer being composed of units derived from propylene in an amount of more than 50 mol-%.

Controlled-rheology polypropylene composition is a polypropylene composition in which the rheology, indicated e.g. by its molecular weight Mw or melt flow rate MFR₂, is controlled by degradation induced by means of a rheology control agent.

### DETAILED DESCRIPTION OF THE INVENTION

In one aspect the present invention relates to a controlled-rheology polypropylene composition (CR-PP)
originating from a polypropylene composition (PP) comprising a mixed-plastics polypropylene based blend,
wherein the controlled-rheology polypropylene composition has
a melt flow rate MFR₂ of at least 10 g/10 min, such as in the range of from 10 to 250 g/10 min, preferably from 15 to 225 g/10 min, more preferably from 25 to 200 g/10 min, still more preferably from 40 to 175 g/10 min, most preferably from 65 to 150 g/10 min, determined according to ISO 1133-1:2011 at 230° C. and 2.16 kg, wherein the ratio of the melt flow rate of the controlled-rheology polypropylene composition MFR₂ (CR-PP) to the melt flow rate of the original polypropylene composition MFR₂ (PP) is in the range of from 1.5 to 30.0; and
a volatile organic compounds (VOC) emission in the time interval of 3.0 to 8.5 minutes of not more than 2.8 μg/g, such as in the range of from 1.5 to 2.7 μg/g, preferably from 1.7 to 2.6 μg/g, more preferably from 2.0 to 2.5 μg/g, determined by GC-MS.

The controlled-rheology polypropylene composition originates from a polypropylene composition comprising a mixed-plastics polypropylene based blend.

Said non-modified polypropylene composition comprising a mixed-plastics polypropylene composition in the following is also denoted “original polypropylene composition”.

The original polypropylene composition is modified in the presence of a non-peroxide rheology control agent to obtain the controlled-rheology polypropylene composition as described below in the process section.

The mixed-plastics polypropylene based blend present in the original (non-modified) polypropylene composition is suitably characterized by CRYSTEX QC analysis. In the CRYSTEX QC analysis, a crystalline fraction (CF) and a soluble fraction (SF) are obtained which can be quantified and analyzed in regard of the monomer and comonomer content as well as the intrinsic viscosity (iV).

The mixed-plastics polypropylene based blend shows the following properties in the CRYSTEX QC analysis:
a crystalline fraction (CF) content determined according to CRYSTEX QC analysis in the range from 85.0 to 96.0 wt.-%, preferably in the range from 86.5 to 95.5 wt.-%, more preferably in the range from 88.0 to 95.0 wt.-%; and
a soluble fraction (SF) content determined according to CRYSTEX QC analysis in the range from 4.0 to 15.0 wt.-%, preferably in the range from 4.5 to 13.5 wt.-%, more preferably in the range from 5.0 to 12.0 wt.-%.

Said crystalline fraction (CF) has one or more, preferably all of the following properties:
an ethylene content (C2(CF)), as determined by FT-IR spectroscopy calibrated by quantitative ¹³C-NMR spectroscopy, in the range from 3.0 to 12.5 wt.-%, preferably in the range from 4.0 to 11.0 wt.-%, more preferably in the range from 5.0 to 10.0 wt.-%; and/or
an intrinsic viscosity (iV(CF)), as measured in decalin according to DIN ISO 1628/1 at 135° C., preferably in the range from 1.2 to 2.4 dl/g, more preferably in the range from 1.3 to 2.2 dl/g, still more preferably in the range from 1.4 to 2.0 dl/g.

Said soluble fraction (SF) has one or more, preferably all of the following properties:
an ethylene content (C2(SF)), as determined by FT-IR spectroscopy calibrated by quantitative ¹³C-NMR spectroscopy, preferably in the range from 20.0 to 40.0 wt.-%, preferably in the range from 22.0 to 37.0 wt.-%, more preferably in the range from 24.0 to 34.0 wt.-%; and/or
an intrinsic viscosity (iV(SF)), as measured in decalin according to DIN ISO 1628/1 at 135° C., in the range from 0.9 to 2.0 dl/g, preferably in the range from 1.0 to 1.9 dl/g, more preferably in the range from 1.1 to 1.7 dl/g.

Preferably, the mixed-plastics polypropylene based blend comprises polypropylene and polyethylene.

The weight ratio of polypropylene to polyethylene usually is from 99.5:0.5 to 70:30; preferably from 99:1 to 80:20; more preferably from 97:3 to 82:18.

The mixed-plastics polypropylene based blend preferably comprises units derived from propylene in an amount of more than 50 mol-%.

The mixed-plastics polypropylene based blend preferably comprises units derived from ethylene in an amount of from 2.5 to 20.0 wt.-%, more preferably from 4.0 to 17.5 wt.-%, still more preferably from 5.0 to 15.0 wt.-%, determined by NMR.

Further, the mixed-plastics polypropylene based blend preferably has one or more, preferably all of the following properties:
a melt flow rate MFR₂ (230° C., 2.16 kg, ISO1133) of 8.0 to 30.0 g/10 min, preferably of 9.0 to 25.0 g/10 min, more preferably of 12.0 to 20.0 g/10 min; and/or
a limonene content as determined by using solid phase microextraction (HS-SPME-GC-MS): 0.1 ppm to 50 ppm; and/or
a chalk content as determined by IR of 0 to 1.5 wt %, preferably 0.01 to 1.0 wt %, more preferably 0.1 to 0.7 wt %; and/or
a polyamide content as determined by IR of 0 to 1.5 wt %, preferably 0 to 1.0 wt %, more preferably 0 to 0.7 wt %; and/or
a polystyrene content as determined by IR of 0.1 to 2.0 wt %, preferably 0.2 to 1.5 wt %, more preferably 0.3 to 1.2 wt %; and/or
a talc content as determined by IR of 0 to 1.5 wt %, preferably 0.01 to 1.0 wt %, more preferably 0.1 to 0.7 wt %; and/or
a polypropylene (iPP) content as determined by IR of 80 to 99 wt %, preferably 82 to 98 wt %, more preferably 84 to 96 wt %.

The mixed-plastics polypropylene based blend preferably is a post-consumer recyclate polypropylene based blend and/or a post-industrial recyclate polypropylene based blend.

The mixed-plastics polypropylene based blend is preferably present in the original polypropylene composition in an amount of from 25.0 wt % to 99.999 wt %, preferably from 29.0 to 99.995 wt %, more preferably from 40.0 to 99.99 wt %, even more preferably from 50.0 to 99.9 wt %, based on the total weight of the original polypropylene composition.

The original polypropylene composition can comprise other polymeric components in an amount of 0 to 74.9 wt %, preferably from 0 to 70.9 wt %, still more preferably from 0 to 59.9 wt % and even more preferably from 0 to 49.9 wt %, based on the total weight of the original polypropylene composition.

The other polymeric components are preferably polypropylene resins, such as propylene homopolymers, propylene random copolymers or heterophasic propylene copolymers.

The other polymeric components can be virgin polymeric components or recyclate polymer components originating e.g. from post-consumer recyclate polymer blends and/or post-industrial recyclate polymer blends. Preferably the other polymeric components are virgin polymeric components.

The other polymeric components are usually added to the original polypropylene composition for adapting the properties of the original polypropylene composition for its later use.

The original polypropylene composition is blended with a non-peroxide rheology control agent to obtain the rheology-controlled polypropylene composition preferably by compounding.

Thereby, the non-peroxide rheology control agent is added to the original polypropylene composition in an amount of from 0.001 to 5.0 wt %, more preferably 0.005 to 2.5 wt %, still more preferably from 0.01 to 1.5 wt %, based on the total weight of the combined original polypropylene composition and non-peroxide rheology control agent.

The non-peroxide rheology control agent is suitable for increasing the melt flow rate of the original polypropylene composition to obtain the rheology controlled polypropylene composition, preferably at elevated temperature, suitably during compounding.

The non-peroxide rheology control agent preferably comprises at least two components (I) and (II).

Component (I) preferably is a piperazyl-ester derivative, such as a (1,2,2,6,6-pentaalkyl-4-piperidyl)ester derivative with the alkyl residues at 1, 2, 2, 6 and 6 position preferably independently selected from C₁ to C₁₂ alkyl groups, more preferably from C₁ to C₄ alkyl groups, such as methyl, ethyl, propyl, n-butyl, isobutyl or tert-butyl groups, more preferably from methyl or ethyl groups. Most preferably all alkyl residues at 1, 2, 2, 6 and 6 position are methyl groups. Especially suitable as component (I) is sebacic acid-bis(1,2,2,6,6-pentamethyl-4-piperidyl)ester, illustrated in formula (I)

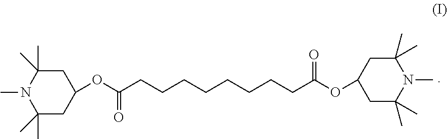

Component (II) preferably is an aromatic carbonyl component, more preferably an aromatic dicarbonyl component, still more preferably an aromatic diketone component.

Especially suitable as component (II) is 1,4-diacetylbenzene, illustrated in formula (II)

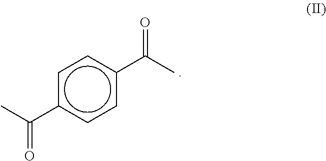

The non-peroxide rheology control agent is preferably added to the original polypropylene composition in form of a masterbatch in which the at least two components are present in a polymeric matrix.

In the preferred embodiment that the non-peroxide rheology control agent is added to the original polypropylene composition in form of a masterbatch, the polymeric compounds of the polymeric matrix are counted to the non-peroxide rheology control agent.

In said embodiment the amounts of the compounds (I) and (II) added to the original polypropylene composition are preferably in the range of from 0.001 to 1.0 wt %, more preferably from 0.005 to 0.5 wt %, still more preferably from 0.01 to 0.3 wt %, based on the combined weight of the original polypropylene composition. Alternatively the non-peroxide rheology control agent is added to the original polypropylene composition in its pure form.

The non-peroxide rheology control agent does not comprise peroxide, i.e. is free of a peroxide, such as an organic peroxide.

It is further preferred that the original polypropylene composition does not comprise peroxide, i.e. is free of a peroxide, such as an organic peroxide.

The original polypropylene composition can further comprise additives such as additives selected from one or more of antioxidant(s), UV stabilizer(s), slip agent(s), nucleating agent(s), pigment(s), lubricant(s), masterbatch polymer(s) and/or anti-fogging agents.

Additives are usually present in the composition in an amount of up to 4.0 wt %, such as from 0.01 to 4.0 wt.-%, preferably in an amount of 0.05 to 3.0 wt.-%, based on the total weight of the original polypropylene composition.

The original polypropylene composition usually has a melt flow rate MFR₂ (230° C., 2.16 kg, ISO1133) of 8.0 to 40 g/10 min, preferably of 9.0 to 35 g/10 min, more preferably of 10.0 to 30 g/10 min.

The rheology-controlled polypropylene composition is preferably obtained from the original polypropylene composition by compounding the original polypropylene composition with the non-peroxide rheology control agent and optional additives at a maximum temperature of less than 250° C., preferably in the range of from 160 to 230° C., more preferably in the range of from 200 to 220° C.

During said compounding step the polymeric components of the original polypropylene composition are degraded so that the melt viscosity of the compounded composition is reduced, which can be measured as an increased melt flow rate in the final rheology-controlled polypropylene composition. The rate of degradation can be controlled e.g. by controlling the amount of non-peroxide rheology control agent or by controlling the compounding conditions, such as the compounding temperature profile.

The thus obtained controlled-rheology polypropylene composition has a melt flow rate MFR₂ of at least 10 g/10 min, such as in the range of from 10 to 250 g/10 min, preferably from 15 to 225 g/10 min, more preferably from 25 to 200 g/10 min, still more preferably from 40 to 175 g/10 min, most preferably from 65 to 150 g/10 min, determined according to ISO 1133-1:2011 at 230° C. and 2.16 kg.

The ratio of the melt flow rate of the controlled-rheology polypropylene composition MFR₂ (CR-PP) to the melt flow rate of the original polypropylene composition MFR₂ (PP) is in the range of from 1.5 to 30.0, preferably from 1.7 to 25.0, more preferably from 2.0 to 20.0.

The controlled-rheology polypropylene composition is characterized by a specific pattern of degradation products which can be analysed as volatile organic compounds (VOC). VOCs are defined as any organic compound having an initial boiling point of less than or equal to 250° C. measured at a standard atmospheric pressure of 101.3 kPa (EU VOC solvents Emissions Directive 199/13/EC) and therefore are prone for analysis via GC-MS.

It is preferred that the controlled-rheology polypropylene composition has a total volatile organic compounds (VOC) content of less than 500 μg/g, such as in the range of from 50 to 450 μg/g, more preferably from 150 to 400 μg/g, still more preferably from 200 to 350 μg/g, determined according to VDA 278.

In a gas chromatography-mass spectrometry (GC-MS) analysis the volatile organic compounds can be analysed by their GC-MS peaks over time. Thereby, the controlled-rheology polypropylene composition shows a characteristically low emission of volatile organic compounds (VOC) at the early time interval of 3.0 to 8.5 minutes.

The controlled-rheology polypropylene composition has a volatile organic compounds (VOC) emission in the time interval of 3.0 to 8.5 minutes of not more than 2.8 μg/g, such as in the range of from 1.5 to 2.7 μg/g, preferably from 1.7 to 2.6 μg/g, more preferably from 2.0 to 2.5 μg/g, determined by GC-MS.

Further, the controlled-rheology polypropylene composition preferably has a volatile organic compounds (VOC) emission in the time interval of 3.0 to 4.0 minutes of not more than 1.5 μg/g, such as in the range of from 0.1 to 1.5 μg/g, more preferably from 0.3 to 1.3 μg/g, still more preferably from 0.5 to 1.0 μg/g, determined by GC-MS.

Still further, the controlled-rheology polypropylene composition preferably has a volatile organic compounds (VOC) emission in the time interval of 16.5 to 21.5 minutes of not more than 50.0 μg/g, such as in the range of from 15.0 to 50.0 μg/g, more preferably from 20.0 to 40.0 μg/g, still more preferably from 22.5 to 30.0 μg/g, determined by GC-MS.

Furthermore, the controlled-rheology polypropylene composition preferably has a volatile organic compounds (VOC) emission in the time interval of 32.0 to 34.5 minutes of not more than 80.0 μg/g, such as in the range of from 35.0 to 80.0 μg/g, more preferably from 40.0 to 77.5 μg/g, still more preferably from 50 to 76.0 μg/g, determined by GC-MS.

The above mentioned volatile organic compounds (VOC) emissions are determined by GC-MS, preferably on a column having a length of 50 m and/or a diameter of 0.32 mm and/or a layer thickness of 0.52 μm. It is preferred that the column is a fused silica column. Further, it is preferred that the column comprises a non-polar, bonded and cross linked material containing 5% phenylpolysiloxane and 95% methylpolysiloxan.

The GC-MS measurement is preferably carried out with a carrier gas flow, preferably Helium gas flow of 2.0 mL/min and/or an initial oven temperature of 40° C. which is maintained for 2 minutes followed by heating up to 92° C. at a heating rate of 3° C. min⁻¹, then heating up to 160° C. at a heating rate of 5° C. min⁻¹, then heating up to a final temperature of 280° C. at a heating rate of 10° C. min⁻¹, said final temperature being maintained for 10 minutes.

The volatile organic compounds (VOC) can also be individually identified by GC-MS.

It is thereby preferred that the relative content of a compound selected from the group of alpha-methylstyrene, acetophenone, 2-phenylpropan-2-ol, 2-ethoxy-2-methyl-propane, amylene hydrate, 2-butanone, ethylacetate and 2-[3-(2-hydropropan-2-yl)phenyl]propan-2-ol in the total content volatile organic compounds (VOC) is not more than 1.0%, such as from 0.01 to 1.0%, preferably from 0.05 to 0.9%, more preferably from 0.1 to 0.8%, determined by GC-MS.

These compounds alpha-methylstyrene, acetophenone, 2-phenylpropan-2-ol, 2-ethoxy-2-methyl-propane, amylene hydrate, 2-butanone, ethylacetate and 2-[3-(2-hydropropan-2-yl)phenyl]propan-2-ol can be attributed to residual unreacted organic peroxides and peroxide decomposition products. A low amount of these compounds thus indicates that the degradation of the controlled-rheology polypropylene composition is not caused by peroxides, especially organic peroxides.

Instead the total content volatile organic compounds (VOC) preferably includes compounds selected from the group of 1,3-diacetylbenzene, 1,4-diacetylbenzene, 1-[3-(1-hydroxy-1-methylethyl)phenyl]ethanone and 1-[3-(1-hydroxy-1-methylethyl)phenyl]ethanone in a relative amount of at least 5.0%, such as from 5.0% to 20.0%, more preferably from 10.0% to 18.5%, determined by GC-MS.

The controlled-rheology polypropylene composition preferably has a Young's modulus of at least 900 MPa, such as in the range of from 900 to 1500 MPa, more preferably from 950 to 1400 MPa, still more preferably from 1000 to 1350 MPa.

Further, the controlled-rheology polypropylene composition preferably has a yield strength of at least 20 MPa, such as in the range of from 20 to 40 MPa, more preferably from 21 to 37 MPa, still more preferably from 22 to 35 MPa.

Still further, the controlled-rheology polypropylene composition preferably has a strain at break of at least 5.0%, such as in the range of from 5.0 to 35%, more preferably from 7.5 to 32%, still more preferably from 9.0 to 30%.

Furthermore, the controlled-rheology polypropylene composition preferably has a Charpy notched impact strength measured at 23° C. of at least 3.5 kJ/m², such as in the range of from 3.5 to 7.5 kJ/m², more preferably from 4.0 to 6.5 kJ/m², still more preferably from 4.5 to 6.0 kJ/m².

In a further aspect, the present invention relates to a process for producing the controlled-rheology polypropylene composition as described above or below comprising the steps of:
Providing a polypropylene composition comprising a mixed-plastics polypropylene based blend;
Mixing the polypropylene composition with a non-peroxide rheology control agent;
Compounding the polypropylene composition with the non-peroxide rheology control agent at a maximum temperature of less than 250° C., preferably in the range of from 160 to 230° C., more preferably in the range of from 200 to 220° C.

Thereby, the polypropylene composition comprising a mixed-plastics polypropylene based blend preferably reflects all embodiments and properties of the original polypropylene composition as described above or below.

Further, the non-peroxide rheology control agent preferably reflects all embodiments and properties of the non-peroxide rheology control agent as described above or below.

Still further, the controlled-rheology polypropylene composition preferably reflects all embodiments and properties of the controlled-rheology polypropylene composition as described above or below.

The original polypropylene composition is preferably compounded with the non-peroxide rheology control agent and optional additives, preferably as described above or below, at a maximum temperature of less than 250° C., preferably in the range of from 160 to 230° C., more preferably in the range of from 200 to 220° C.

The weight ratio of the original polypropylene composition and the non-peroxide rheology control agent is preferably in the range of from 99.999:0.001 to 95.0:5.0, more preferably from 99.995:0.005 to 97.5:2.5, still more preferably from 99.99:0.01 to 98.5:1.5.

The compounding step is preferably conducted in an extruder. Preferred extruders are e.g. single-screw extruders, contra-rotating and co-rotating twin-screw extruders, planetary-gear extruders, ring extruders or co-kneaders. It is also possible to use extruders provided with at least one gas removal compartment to which a vacuum can be applied.

Suitable extruders and kneaders are described, for example, in Handbuch der Kunststoffextrusion, Vol. 1 Grundlagen, Editors F. Hensen, W Knappe, H. Potente, 1989, pp. 3-7, ISBN:3-446-14339-4 (Vol. 2 Extrusionsanlagen 1986, ISBN 3-446-14329-7).

In yet another aspect, the present invention relates to an article comprising the controlled-rheology polypropylene composition as described above or below.

Thereby, the controlled-rheology polypropylene composition preferably reflects all embodiments and properties of the controlled-rheology polypropylene composition as described above or below.

The article preferably is an injection moulded article, a non-woven article, like a melt blown non-woven article, or a film.

For the production of the article the controlled-rheology polypropylene composition can be melt blended with other polymeric components, additives, pigments and/or fillers.

The other polymeric components are preferably polypropylene resins, such as propylene homopolymers, propylene random copolymers or heterophasic propylene copolymers.

The other polymeric components can be virgin polymeric components or recyclate polymer components originating e.g. from post-consumer recyclate polymer blends and/or post-industrial recyclate polymer blends.

The polymeric components are usually added to the original polypropylene composition for adapting the properties of the article.

The controlled-rheology polypropylene composition preferably is present in the article in an amount of from 25 to 100 wt %, more preferably from 35 to 100 wt %, still more preferably from 50 to 100 wt %, based on the total weight of the article.

In a final aspect, the present invention relates to the use of the controlled-rheology polypropylene composition as described above or below for the production of an article comprising a mixed-plastics polypropylene based blend.

Thereby, the controlled-rheology polypropylene composition, the mixed-plastics polypropylene based blend and the article preferably reflects all embodiments and properties of the controlled-rheology polypropylene composition the mixed-plastics polypropylene based blend and the article as described above or below.

### Experimental Section

The following Examples are included to demonstrate certain aspects and embodiments of the invention as described in the claims. It should be appreciated by those of skill in the art, however, that the following description is illustrative only and should not be taken in any way as a restriction of the invention.

### 1. Test Methods

### CRYSTEX

Determination of Crystalline and Soluble Fractions and their Respective Properties (IV and Ethylene Content)

The crystalline (CF) and soluble fractions (SF) of the polypropylene compositions as well as the comonomer content and intrinsic viscosities of the respective fractions were analyzed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596)

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (iV) an online 2-capillary viscometer is used.

The IR4 detector is a multiple wavelength detector measuring IR absorbance at two different bands (CH₃ stretching vibration (centred at app. 2960 cm⁻¹) and the CH stretching vibration (2700-3000 cm⁻¹) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$( Equation 1 )$$

$$Conc = a + b * Abs ( CH ) + c * {( Abs ( CH ) )}^{2} + d * Abs ( {CH}_{3} ) + e * ( {Abs ( {CH}_{3} )}^{2} + f * Abs ( CH ) * Abs ( {CH}_{3} )$$

$$( Equation 2 )$$

$${CH}_{3} / 1000 C = a + b * Abs ( CH ) + c * Abs ( {CH}_{3} ) + d * ( Abs ( {CH}_{3} ) / Abs ( CH ) ) + e * {( Abs ( {CH}_{3} ) / Abs ( CH ) )}^{2}$$

The constants a to e for equation 1 and a to f for equation 2 were determined by using least square regression analysis.

The CH₃/1000 C is converted to the ethylene content in wt.-% using following relationship:

$$( Equation 3 )$$

$$wt . - \% ( Ethylene in EP Copolymers ) = 100 - {CH}_{3} / 1000 TC * 0.3$$

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt.-%. The determined XS calibration is linear:

$$wt . - \% XS = 1 , 01 * wt . - \% SF \qquad ( Equation 4 )$$

Intrinsic viscosity (iV) of the polymer and its soluble and crystalline fractions are determined with a use of an online 2-capillary viscometer and are correlated to corresponding iV's determined by standard method in decalin according to ISO 1628-3. Calibration is achieved with various EP PP copolymers with iV=2-4 dL/g. The determined calibration curve is linear:

$$iV ( dL / g ) = a * Vsp / c \qquad ( equation 5 )$$

The samples to be analyzed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0,077/D 0.05 mm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV [dl/g] and the C2 [wt.-%] of the polymer blend. During the second injection the soluble fraction (at low temperature) and the crystalline fraction (at high temperature) with the crystallization cycle are measured (wt.-% SF, wt.-% C2, iV)) where the wt.-% CF is calculated in the following way:

$$wt . - \% CF = 100 - wt . - \% SF .$$

Amount of “iPP”, “PVC”, “PA”, “PET”, “PS”, Etc. Determination by Transmission

### Infra-Red Spectroscopy

### Sample Preparation:

All calibration samples and samples to be analyzed are prepared in similar way, on molten pressed plates.

Around 2 to 3 g of compounds to be analyzed are molten at 190° C. Subsequently, for 20 seconds 60 to 80 bar pressure is applied in a hydraulic heating press. Next, the samples are cooled down to room temperature in 40 second in a cold press under the same pressure, in order to control the morphology of the compound. The thickness of the plates are controlled by metallic calibrated frame plates 2.5 cm by 2.5 cm, 100 to 200 μm thick (depending MFR from the sample); two plates are produced in parallel at the same moment and in the same conditions. The thickness of each plate is measured before any FTIR measurements; all plates are between 100 to 200 μm thick.

To control the plate surface and to avoid any interference during the measurement, all plates are pressed between two double-sided silicone release papers.

In case of powder samples or heterogeneous compounds, the pressing process would be repeated three times to increase homogeneity by pressed and cutting the sample in the same conditions as described before.

### Spectrometer:

Standard transmission FTIR spectroscope such as Bruker Vertex 70 FTIR spectrometer is used with the following set-up:
a spectral range of 4000-400 cm⁻¹,
an aperture of 6 mm,
a spectral resolution of 2 cm⁻¹,
with 16 background scans, 16 spectrum scans,
an interferogram zero filling factor of 32
Norton Beer strong apodisation.

Spectrum are recorded and analysed in Bruker Opus software.

### Calibration Samples:

As FTIR is a secondary method, several calibration standards were compounded to cover the targeted analysis range, typically from:
0.2 wt % to 2.5 wt % for polyamide (PA)
0.1 wt % to 5 wt % for polystyrene (PS)
0.2 wt % to 2.5 wt % for polyethylene terephthalate (PET)
0.1 wt % to 4 wt % for polyvinyl chloride (PVC)

The following commercial materials were used for the compounds:
Borealis HC600TF as iPP, Borealis FB3450 as HDPE and for the targeted polymers such as RAMAPET N1S
(Indorama Polymer) for PET, Ultramid® B36LN (BASF) for Polyamide 6, Styrolution PS 486N (Ineos) for High Impact Polystyrene (HIPS), and for PVC Inovyn PVC 263B (under powder form).

All compounds are made at small scale in a Haake kneader at a temperature below 265° C. and less than 10 minutes to avoid degradation.

Additional antioxidant such as Irgafos 168 (3000 ppm) is added to minimize the degradation.

### Calibration:

The FTIR calibration principal is the same for all the components: the intensity of a specific FTIR band divided by the plate thickness is correlated to the amount of component determined by ¹H or ¹³C solution state NMR on the same plate.

Each specific FTIR absorption band is chosen due to its intensity increase with the amount of the component concentration and due to its isolation from the rest of the peaks, whatever the composition of the calibration standard and real samples.

This methodology is described in the publication from Signoret and al. “Alterations of plastic spectra in MIR and the potential impacts on identification towards recycling”, Resources, conservation and Recycling journal, 2020, volume 161, article 104980.

The wavelength for each calibration band is:
3300 cm⁻¹ for PA,
1601 cm⁻¹ for PS,
1410 cm-1 for PET,
615 cm⁻¹ for PVC,
1167 cm⁻¹ for iPP.

For each polymer component i, a linear calibration (based on linearity of Beer-Lambert law) is constructed. A typical linear correlation used for such calibrations is given below:

$${x}_{i} = {A}_{i} \cdot \frac{{E}_{i}}{d} + {B}_{i}$$

where
xᵢ is the fraction amount of the polymer component i (in wt %)
Eᵢ is the absorbance intensity of the specific band related to the polymer component i (in a.u. absorbance unit). These specific bands are, 3300 cm⁻¹ for PA, 1601 cm⁻¹ for PS, 1410 cm⁻¹ for PET, 615 cm⁻¹ for PVC, 1167 cm⁻¹ for iPP
d is the thickness of the sample plate
Aᵢ and B₁ are two coefficients of correlation determined for each calibration curve

The following bands are used to estimate the EVA, Chalk and Talc contents:
EVA: band centred at 607 cm⁻¹
Chalk: band centred at 1798 cm⁻¹
Talc: band centred at 3676 cm⁻¹

For each calibration standard, wherever available, the amount of each component is determined by either ¹H or ¹³C solution state NMR, as primary method (except for PA). The NMR measurements are performed on the exact same FTIR plates used for the construction of the FTIR calibration curves.

### Quantification of Microstructure by NMR Spectroscopy

Quantitative nuclear-magnetic resonance (NMR) spectroscopy was used to quantify the ethylene content of the polymers.

Quantitative ¹³C{¹H} NMR spectra were recorded in the solution-state using a Bruker Avance Neo 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in approximately 3 ml of 1,2-tetrachloroethane-d₂ (TCE-d₂) along with approximately 3 mg BHT (2,6-di-tert-butyl-4-methylphenol CAS 128-37-0) and chromium-(III)-acetylacetonate (Cr(acac)₃) resulting in a 60 mM solution of relaxation agent in solvent as described in G. Singh, A. Kothari, V. Gupta, Polymer Testing 2009, 28(5), 475.

To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6 k) transients were acquired per spectra. Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

Characteristic signals corresponding to the incorporation of ethylene were observed (as described in Cheng, H. N., Macromolecules 1984, 17, 1950) and the comonomer fraction calculated as the fraction of ethylene in the polymer with respect to all monomer in the polymer:

$$fE = ( E / ( P + E ) )$$

The comonomer fraction was quantified using the method of W-J. Wang and S. Zhu, Macromolecules 2000, 33 1157, through integration of multiple signals across the whole spectral region in the ¹³C{¹H} spectra. Integral regions were slightly adjusted to increase applicability across the whole range of encountered comonomer contents. The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

### Melt Flow Rate (MFR)

The MFR measurements were conducted at 230° C. and with 2.16 kg on a Zwick/Roell Mflow melt flow indexer (Zwick Roell, Germany) according to ISO 1133-1:2011 (Plastics—Determination of the melt mass-flow rate (MFR) and melt volume-flow rate (MVR) of thermoplastics—Part 1: Standard method). Cuts were made every 5 mm piston movement. The time between cuts was measured and each extrudate was weighted on an ABS 220-4 electronic balance (Kern & Sohn, Germany). The extrapolation to 10 minutes calculated the MFR in g/10 min for each cut. For each material, one measurement was conducted. Within one measurement, 6 cuts were made and used for the calculation of average values.

### Production of Multipurpose Specimens (MPS) and Charpy Type 1 Specimen

All MPS were produced via injection molding according to ISO 3167 (Plastics—Multipurpose test specimens) and ISO 19069-2 (Plastics—Polypropylene (PP) molding and extrusion materials—Part 2: Preparation of test specimens and determination of properties) on an Engel Victory 60 (Engel, Austria). Specimens were conditioned at 23° C. and 50% relative humidity for at least three days. After conditioning, these specimens were used for tensile testing. Furthermore, Type 1 specimens for Charpy notched impact testing according to ISO 179-1 were produced by injection molding and subsequently notched after being conditioned at 23° C. and 50% relative humidity for at least three days. Testing was conducted after an additional time of at least 16 hours at 23° C. and 50% relative humidity.

### Tensile Properties

The mechanical properties (Young's modulus, yield strength and strain-at-break) were examined with a universal testing machine Zwick AllroundLine Z020 (Zwick Roell, Germany) equipped with a multi-extensometer at 23° C. Test parameters and MPS were used according to ISO 527-1:2012 (Plastics—Determination of tensile properties—Part 1: General principles) and ISO 527-2:2012 (Part 2: Test conditions for moulding and extrusion plastics) with a traverse speed of 1 mm/min for Young's modulus determination until a strain of 0.25% and after that 50 mm/min until failure. For each material five MPS were tested for the calculation of average values.

### Charpy Notched Impact Strength

Impact tests were conducted according to ISO 179-1:2010 (Plastics—Determination of Charpy impact properties—Part 1: Non-instrumented impact test) on a Zwick/Roell HIT25P pendulum impact tester (Zwick Roell, Germany). After pretests to determine the suitable pendulum size, a 0.5 Joule pendulum was chosen for all tests. Notches were produced with a Leica RM2265 microtome (Leica, Germany) and measured on a Mitotoyo notch depth micrometer (Wels, Austria). Test conditions were 23° C. with edgewise notched specimen with 0.25 mm notch-radius (1 eA). For each material ten specimens were tested for the calculation of average values.

### GC-MS Analysis

The analyzed materials were compounded on the same day and stored in closed aluminum bottles for 3 days until they were pressed into plates of Ø=25 mm×1 mm at 180° C. The pressed plates were stored at room temperature in plastic bags for 5 days. For each material two samples with a size of 4 mm×30 mm were punched out of the previously pressed plates.

Qualitative and (semi-)quantitative determination of volatile organic compounds (VOCs) were conducted according to a method based on VDA 278. The measurements were performed on a gas chromatograph coupled to a mass spectrometer (GC-MS) of the type Clarus 690 SQ 8 (PerkinElmer, USA), which was equipped with an automated thermal desorption unit (ATD) of the type TurboMatrix 650 (PerkinElmer, USA). Separation of the VOCs was performed on a non-polar HP Ultra 2 (Agilent Technologies, USA) with a Helium (He) gas flow and temperature program according to Table 1. Thermal desorption of the VOCs was promoted at 90° C. for 30 min according to VDA 278.

The qualitative evaluation was done using the TurboMass software 6.1.2.2024 including NIST/EPA/NIH Mass Spectral Library 2.2. For (semi-)quantitative results, a one-point calibration with a standard of 0.5 mg mL⁻¹ toluene in methanol was conducted prior to the measurements. To be able to measure the calibration solution, 4 μL of the solution were loaded via the autosampler on a packed column injector coupled to a sample tube filled with Tenax TA. The injector was heated to 430° C. and purged with a He gas flow of 20 mL min⁻¹ for 30 min. Additionally, a blank was performed with 4 μL Methanol (VWR Chemicals, USA). Thermal desorption of the calibration standard was promoted at 280° C. for 30 min according to VDA 278. Furthermore, before every material analysis a blank of an empty sample tube was performed. Samples are measured in duplicates. The highest value of the two samples measured represented the VOC value in μg g⁻¹ sample.

As described above, the VOC emission values were determined via an external one-point calibration with a toluene standard solution. The ratio of the mass of toluene m_{std} in μg loaded onto the Tenax TA filled sample tube to the corresponding peak area gives the so-called response factor Rf (see formula below).

$$Rf = \frac{{m}_{std}}{{Area}_{std}} * {10}^{6}$$

This factor was subsequently multiplied with the quotient of the sample peak area and the mass of the sample mₛ in mg giving the semi-quantitative VOC emission values in μg/g.

$$VOC Emission = Rf * \frac{{Area}_{s}}{{10}^{3} * {m}_{s}}$$

This evaluation can be applied to the entire chromatogram derived from a given GC-MS measurement to obtain the total VOC content as well as to fractions thereof, i.e. specific time intervals within a given chromatogram. The latter gives a semi-quantitative VOC emission value associated with individual peaks or groups of peaks, i.e. individual substances or groups of substances, within a specified time interval of the respective chromatogram. Note that the terms VOC content and VOC emission are used interchangeably in the context of this patent.

TABLE 1
Parameters of ATD and GC-MS.

| ATD Parameters | | GC-MS Parameters | |
|---|---|---|---|
| Mode | 2 Stage Desorption | Transfer Line Temperature | 280 |
| | | to MSD/° C. | |
| Column Flow/mL min⁻¹ | 2.0 | Mass Range of Scan Mode/amu | 29-450 |
| Desorption Flow/mL min⁻¹ | 40 | Solvent Delay/min | 2 |
| Inlet Split Flow/mL min⁻¹ | 44 | Temperature Program: | |
| Outlet Split Flow/mL min⁻¹ | 19 | Start Temperature | 40° C., 2 min |
| Trap Temperature/° C. | −30 to 280 | Ramp 1 | 3° C. min⁻¹ to 92° C. |
| Heating Rate/K s⁻¹ | 99 | Ramp 2 | 5° C. min⁻¹ to 160° C. |
| Trap Hold/min | 20 | Ramp 3 | 10° C. min⁻¹ to 280° C. |
| Valve Temperature/° C. | 280 | End Temperature | 280° C., 10 min |
| Transfer Line Temperature/° C. | 290 | | |

### 2. Materials

Blend A: Table 1 shows the properties of the mixed plastics polypropylene based blends (blend A) as used for the evaluation. As these blends come from a mechanical recycling process, the properties are indicated as ranges.

TABLE 2
Properties of the mixed plastics polypropylene
based blends (Blend A)

| | Blend A |
|---|---|
| PP/PE ratio | 95:5-85:15 |
| IR - Chalk (%) | 0.2-0.6 |
| IR - PA (%) | 0-0.5 |
| IR - PS (%) | 0.6-1.0 |
| IR - Talc (%) | 0.2-0.6 |
| IR - iPP (%) | 85-95 |
| NMR wtC2total, wt % | 5-15 |
| C2 total (CRYSTEX), wt % | 5-15 |
| iV total (CRYSTEX), dl/g | 1.6-1.8 |
| Recycling origin | Yes, household waste |
| limonene | >0.1 ppm |
| MFR₂ (230° C., ISO1133), g/10 min | 12.0-20.0 |
| CF (CRYSTEX), wt % | 90.0-92.0 |
| iV (CF), dl/g | 1.6-1.8 |
| C2 (CF), wt % | 6.0-9.0 |
| SF (CRYSTEX), wt % | 8.0-10.0 |
| iV (SF), dl/g | 1.2-1.5 |
| C2 (SF), wt % | 27-30 |

PP B is a virgin heterophasic propylene copolymer having a melt flow rate MFR₂ (230° C., 2.16 kg, ISO 1133) of 0.25 g/10 min, a flexural modulus (ISO 178) of 2000 MPa and a Charpy notched impact strength (23° C., ISO 179-1) of 30 kJ/m², commercially available from Borealis AG.

PP C is a virgin heterophasic propylene copolymer having a melt flow rate MFR₂ (230° C., 2.16 kg, ISO 1133) of 100 g/10 min, a flexural modulus (ISO 178) of 1500 MPa and a Charpy notched impact strength (23° C., ISO 179-1) of 4 kJ/m², commercially available from Borealis AG.

PP D is a virgin heterophasic propylene copolymer having a melt flow rate MFR₂ (230° C., 2.16 kg, ISO 1133) of 35 g/10 min, a flexural modulus (ISO 178) of 1600 MPa and a Charpy notched impact strength (23° C., ISO 179-1) of 6.5 kJ/m², commercially available from Borealis AG.

Rheology control agent RCA 1 is a non-peroxide rheology control agent comprising sebacic acid-bis(1,2,2,6,6-pentamethyl-4-piperidyl)ester and 1,4-diacetylbenzene in a polymeric matrix, commercially available as GRAFTALEN MB EB-150H05 from Lehmann & Voss & Co. KG

Rheology control agent RCA 2 is 3,6,9-Triethyl-3,6,9-trimethyl-1,4,7-triperoxonane, 20% on polypropylene, commercially available as Trigonox® 301-20PP from Nouryon.

Rheology control agent RCA 3 is a peroxide containing rheology control agent in a polymeric matrix, commercially available as GRAFTALEN MB EB-150DC10 from Lehmann & Voss & Co. KG

Rheology control agent RCA 4 is 2,5-Dimethyl-2,5-di(tert-butylperoxy) hexane, in a polymeric matrix, commercially available as Trigonox 101-20PP from Nouryon.

Rheology control agent RCA 5 is a peroxide masterbatch, commercially available as Polyvel CR5P from Polyvel Inc.

### 3. Compounding Conditions

For the production of the rheology-controlled polypropylene compositions of inventive examples IE1 to IE8 and the comparative examples CE1 to CE4 the following compounding conditions were used. Reference example RE1 reflects 100 wt % blend A compounded using the same conditions:
Extruder: twin-screw co-rotating extruder Leistritz ZSE 18MAXX
Screw speed: 600 U/min
Throughput: 10 kg/h

| | | |
|---|---|---|
| Zone 1 | 30° | C. |
| Zone 2 | 170° | C. |
| Zone 3 | 200° | C. |
| Zone 4 | 205° | C. |
| Zone 5 | 210° | C. |
| Zone 6 | 220° | C. |
| Zone 7 | 210° | C. |
| Zone 8 | 210° | C. |
| Zone 9 | 210° | C. |
| Zone 10 | 210° | C. |
| Zone 11 | 210° | C. |
| Zone 12 | 210° | C. |
| Die | 210° | C. |

The compositions of the examples are shown in Table 3 for IE1 to IE8 and Table 4 for CE1 to CE4 and RE1.

TABLE 3
Compositions of examples IE1 to IE8

| | IE1 | IE2 | IE3 | IE4 | IE5 | IE6 | IE7 | IE8 |
|---|---|---|---|---|---|---|---|---|
| Blend A [wt %] | 99.45 | 99.00 | 55.00 | 55.00 | 55.00 | 55.00 | 55.00 | 55.00 |
| PP B [wt %] | — | — | 44.50 | 44.00 | 43.00 | — | — | — |
| PP C [wt %] | — | — | — | — | — | — | — | 44.50 |
| PP D [wt %] | — | — | — | — | — | 44.50 | 44.00 | — |
| RCA 1 [wt %] | 0.55 | 1.00 | 0.50 | 1.00 | 2.00 | 0.50 | 1.00 | 0.50 |
| RCA 2 [wt %] | — | — | — | — | — | — | — | — |
| RCA 3 [wt %] | — | — | — | — | — | — | — | — |
| RCA 4 [wt %] | — | — | — | — | — | — | — | — |
| RCA 5 [wt %] | — | — | — | — | — | — | — | — |

TABLE 4
Compositions of examples CE1 to CE4 and RE1

| | RE1 | CE1 | CE2 | CE3 | CE4 |
|---|---|---|---|---|---|
| Blend A [wt %] | 100 | 99.00 | 99.00 | 99.60 | 98.50 |
| PP B [wt %] | — | — | — | — | — |
| PP C [wt %] | — | — | — | — | — |
| PP D [wt %] | — | — | — | — | — |
| RCA 1 [wt %] | — | — | — | — | — |
| RCA 2 [wt %] | — | — | 1.00 | — | — |
| RCA 3 [wt %] | — | 1.00 | | — | — |
| RCA 4 [wt %] | — | — | | 0.40 | — |
| RCA 5 [wt %] | — | — | | — | 1.50 |

### 4. Properties of the Rheology Controlled Polypropylene Compositions of the Examples

Inventive example IE1, Reference example RE1 and comparative examples CE1 to CE4 were subjected to GC-MS measurement. Thereby, both total VOC content and VOC emissions in specific GC-MS time intervals were measured. Further, the amounts of specific VOC components were determined from the GC-MS data and the melt flow rates were measured.

The VOC data and the MFR₂ values are listed in Table 5 and the amounts of different VOC components are listed in Table 6 as total amounts and in Table 7 as relative amounts.

TABLE 5
MFR₂ values, total VOC emissions, and VOC emissions determined
over specifically selected time intervals in GC-MS.

| | RE1 | IE1 | CE1 | CE2 | CE3 | CE4 |
|---|---|---|---|---|---|---|
| MFR₂ [g/10 min] | 13.8 | 58.8 | 59.2 | 68.3 | 60.3 | 82.0 |
| Total VOC [μg/g] | 218.6 | 288.3 | 363.8 | 270.3 | 238.6 | 298.1 |
| VOC increase vs. RE1 [%] | | 31.9 | 66.4 | 23.6 | 9.2 | 36.3 |
| VOC at GC-MS interval | n.m. | 0.9 | 0.7 | 6.4 | 5.9 | 0.7 |
| 3.0-4.0 min [μg/g] | | | | | | |
| VOC at GC-MS interval | n.m. | 2.3 | 2.9 | 7.4 | 7.1 | 3.3 |
| 3.0-8.5 min [μg/g] | | | | | | |
| VOC at GC-MS interval | 12.7 | 25.3 | 159.5 | 25.1 | 17.9 | 33.9 |
| 16.5-21.5 min [μg/g] | | | | | | |
| VOC at GC-MS interval | 18.9 | 74.9 | 25.5 | 22.6 | 23.2 | 88.8 |
| 32.0-34.5 min [μg/g] | | | | | | |

n.m. = not measureable, i.e. below detection limit and/or below quantification limit

TABLE 6
total amount of individual VOC components
in μg/g as obtained from GC-MS

| | RE1 | IE1 | CE1 | CE4 |
|---|---|---|---|---|
| Alpha-methylstyrene | n.m. | n.m. | 14.4 | n.m. |
| Acetophenone | n.m. | 1.8 | 99.4 | 1.1 |
| 2-phenylpropan-2-ol | n.m. | n.m. | 29.5 | n.m. |
| 2-ethoxy-2-methyl-propane | n.m. | n.m. | n.m. | n.m. |
| Amylene hydrate | n.m. | n.m. | n.m. | n.m. |
| 2-butanone | n.m. | n.m. | n.m. | n.m. |
| Ethylacetate | n.m. | n.m. | n.m. | n.m. |
| 2-[3-(2-hydroxypropan-2- | n.m. | 0.6 | n.m. | 2.3 |
| yl)phenyl]propan-2-ol | | | | |
| 1,3-Diacetylbenzene | n.m. | 17.3 | 0.8 | 38.6 |
| 1,4-Diacetylbenzene | n.m. | 14.5 | 0.7 | n.m. |
| 1-[3-(1-hydroxy-1- | n.m. | 9.8 | n.m. | 24.0 |
| methylethyl)phenyl]-ethanone | | | | |
| 1-[4-(1-hydroxy-1- | | 9.2 | n.m. | n.m. |
| methylethyl)phenyl]-ethanone | | | | |

n.m. = not measureable,
i.e. below detection limit and/or below quantification limit

TABLE 7
Relative amount of individual VOC components expressed
in % of total VOC content as obtained from GC-MS

| | RE1 | IE1 | CE1 | CE4 |
|---|---|---|---|---|
| Alpha-methylstyrene | n.m. | n.m. | 4.0 | n.m. |
| Acetophenone | n.m. | 0.6 | 27.3 | 0.4 |
| 2-phenylpropan-2-ol | n.m. | n.m. | 8.1 | n.m. |
| 2-ethoxy-2-methyl-propane | n.m. | n.m. | n.m. | n.m. |
| Amylene hydrate | n.m. | n.m. | n.m. | n.m. |
| 2-butanone | n.m. | n.m. | n.m. | n.m. |
| Ethylacetate | n.m. | n.m. | n.m. | n.m. |
| 2-[3-(2-hydroxypropan-2- | n.m. | 0.2 | n.m. | 0.8 |
| yl)phenyl]propan-2-ol | | | | |
| 1,3-Diacetylbenzene | n.m. | 6.0 | 0.2 | 12.9 |
| 1,4-Diacetylbenzene | n.m. | 5.0 | 0.2 | n.m. |
| 1-[3-(1-hydroxy-1- | n.m. | 3.4 | n.m. | 8.1 |
| methylethyl)phenyl]-ethanone | | | | |
| 1-[4-(1-hydroxy-1- | | 3.2 | n.m. | n.m. |
| methylethyl)phenyl]-ethanone | | | | |

n.m. = not measureable,
i.e. below detection limit and/or below quantification limit

Tables 7 and 8 show that the controlled-rheology polypropylene composition of inventive example IE1 shows only minor amounts of volatile organic compounds, such as alpha-methylstyrene, acetophenone, 2-phenylpropan-2-ol, 2-ethoxy-2-methyl-propane, amylene hydrate, 2-butanone, ethylacetate and 2-[3-(2-hydropropan-2-yl)phenyl]propan-2-ol, which can be attributed to residual unreacted organic peroxides and peroxide decomposition products. Only minor amounts of acetophenone have been detected.

From inventive examples IE2 to IE8, the reference example RE1 and comparative example CE1 additionally the mechanical properties were determined as listed in Table 8.

TABLE 8
Mechanical properties of examples IE2 to IE8, RE1 and CE2

| | RE1 | CE2 | IE2 | IE3 | IE4 | IE5 | IE6 | IE7 | IE8 |
|---|---|---|---|---|---|---|---|---|---|
| MFR₂ [g/10 min] | 13.8 | 68 | 120 | 19 | 48 | 143 | 70 | 120 | 113 |
| Charpy NIS [kJ/m²] | 6.2 | 5.2 | 4.8 | 5.4 | 5.0 | 4.7 | 5.9 | 5.0 | 4.9 |
| Young's Modulus [MPa] | 1170 | 1240 | 1080 | 1180 | 1140 | 1090 | 1110 | 1060 | 1060 |
| Yield strength [MPa] | 27.2 | 25.4 | 23.6 | 28.2 | 27.4 | 27.0 | 26.0 | 24.9 | 25.3 |
| Strain at break [%] | 46.5 | 10 | 9.7 | 20.2 | 11.8 | 11.9 | 13.9 | 7.6 | 10.6 |

The controlled-rheology polypropylene compositions of inventive examples IE1-IE8 show an improved balance of properties in regard of high melt flow rate, good impact properties and good mechanical properties. It can be seen when comparing IE2 with RE1 and CE2 that the addition of the non-peroxide rheology control agent in IE2 increases the melt flow rate to a higher extent as the addition of the peroxide rheology control agent in CE2 in the same amount. Thereby, the impact properties and mechanical properties are only impaired by the degradation to a minor extent. The impact properties and mechanical properties can be adapted by adding virgin polypropylene resins to the original polypropylene compositions as can be seen in IE3 to IE8.

1: A controlled-rheology polypropylene composition (CR-PP) originating from a polypropylene composition (PP) comprising a mixed-plastics polypropylene based blend, wherein the controlled-rheology polypropylene composition has a melt flow rate MFR₂ of at least 10 g/10 min determined according to ISO 1133-1:2011 at 230° C. and 2.16 kg, wherein the ratio of the melt flow rate of the controlled-rheology polypropylene composition MFR₂ (CR-PP) to the melt flow rate of the original polypropylene composition MFR₂ (PP) is in the range of from 1.5 to 30.0; and a volatile organic compounds (VOC) emission in the time interval of 3.0 to 8.5 minutes of not more than 2.8 μg/g determined by GC-MS.

2: The controlled-rheology polypropylene composition according to claim 1, having a volatile organic compounds (VOC) emission in the time interval of 3.0 to 4.0 minutes of not more than 1.5 μg/g, and/or a volatile organic compounds (VOC) emission in the time interval of 16.5 to 21.5 minutes of not more than 50.0 μg/g and/or a volatile organic compounds (VOC) emission in the time interval of 32.0 to 34.5 minutes of not more than 80.0 μg/g, all determined by GC-MS.

3: The controlled-rheology polypropylene composition according to claim 1, wherein the relative content of compounds selected from the group of alpha-methylstyrene, acetophenone, 2-phenylpropan-2-ol, 2-ethoxy-2-methyl-propane, amylene hydrate, 2-butanone, ethylacetate and 2-[3-(2-hydropropan-2-yl)phenyl]propan-2-ol in the total content volatile organic compounds (VOC) is not more than 1.0%, such as from 0.01 to 1.0% determined by GC-MS.

4: The controlled-rheology polypropylene composition according to claim 1, having a total volatile organic compounds (VOC) content of less than 500 μg/g, determined according to VDA 278.

5: The controlled-rheology polypropylene composition according to claim 1, having:
a Young's modulus of at least 900 MPa, determined according to ISO 527-1,-2:2012 on multi-purpose injection moulded test specimens prepared according to ISO 3167 and ISO 19069-2; and/or
a yield strength of at least 20 MPa, determined according to ISO 527-1,-2:2012 on multi-purpose injection moulded test specimens prepared according to ISO 3167 and ISO 19069-2; and/or
a strain at break of at least 5.0% determined according to ISO 527-1,-2:2012 on multi-purpose injection moulded test specimens prepared according to ISO 3167 and ISO 19069-2; and/or
a Charpy notched impact strength of at least 3.5 kJ/m² determined according to ISO 179-1:2010 at 23° C. on multi-purpose injection moulded test specimens prepared according to ISO 3167 and ISO 19069-2.

6: The controlled-rheology polypropylene composition according to claim 1, wherein the mixed-plastics polypropylene based blend is a post-consumer recyclate polypropylene based blend and/or a post-industrial recyclate polypropylene based blend.

7: The controlled-rheology polypropylene composition according to claim 1, wherein the mixed-plastics polypropylene based blend is present in the original polypropylene composition in an amount of from 25.0 wt % to 99.999 wt %, based on the total weight of the original polypropylene composition.

8: The controlled-rheology polypropylene composition according to claim 1, wherein the ratio of the melt flow rate of the controlled-rheology polypropylene composition MFR₂ (CR-PP) to the melt flow rate of the original polypropylene composition MFR₂ (PP) is in the range from 1.7 to 25.0.

9: The controlled-rheology polypropylene composition according to claim 1, obtainable by compounding the original polypropylene composition with a non-peroxide rheology control agent at a maximum temperature of less than 250° C.

10: The controlled-rheology polypropylene composition according to claim 9, wherein the non-peroxide rheology control agent comprises at least two components (I) and (II), wherein component (I) is a piperazyl-ester derivative
and component (II) is an aromatic carbonyl component.

11: A process for producing the controlled-rheology polypropylene composition according to claim 1, comprising the steps of:
providing a polypropylene composition comprising a mixed-plastics polypropylene based blend;
mixing the polypropylene composition with a non-peroxide rheology control agent;
compounding the polypropylene composition with the non-peroxide rheology control agent at a maximum temperature of less than 250° C.

12: The process according to claim 11, wherein the weight ratio of the original polypropylene composition and the non-peroxide rheology control agent is in the range of from 99.999:0.001 to 95.0:5.0.

13: An article comprising the controlled-rheology polypropylene composition according to claim 1.

14. (canceled)

15: The controlled-rheology polypropylene composition (CR-PP) according to claim 1, wherein the melt flow rate MFR₂ is in a range of from 25 to 200 g/10 min, determined according to ISO 1133-1:2011 at 230° C. and 2.16 kg.

16: The controlled-rheology polypropylene composition (CR-PP) according to claim 15, wherein the range is of from 40 to 175 g/10 min, determined according to ISO 1133-1:2011 at 230° C. and 2.16 kg.

17: The controlled-rheology polypropylene composition (CR-PP) according to claim 15, wherein the range is of from 60 to 150 g/10 min, determined according to ISO 1133-1:2011 at 230° C. and 2.16 kg.

18: The controlled-rheology polypropylene composition according to claim 1, having:
a Young's modulus of at least 900 MPa, determined according to ISO 527-1,-2:2012 on multi-purpose injection moulded test specimens prepared according to ISO 3167 and ISO 19069-2; and
a yield strength of at least 20 MPa, determined according to ISO 527-1,-2:2012 on multi-purpose injection moulded test specimens prepared according to ISO 3167 and ISO 19069-2; and
a strain at break of at least 5.0%, determined according to ISO 527-1,-2:2012 on multi-purpose injection moulded test specimens prepared according to ISO 3167 and ISO 19069-2; and
a Charpy notched impact strength of at least 3.5 kJ/m², determined according to ISO 179-1:2010 at 23° C. on multi-purpose injection moulded test specimens prepared according to ISO 3167 and ISO 19069-2.

19: The controlled-rheology polypropylene composition according to claim 18, wherein:
the Young's modulus is in a range of from 1000 to 1350 MPa, determined according to ISO 527-1,-2:2012 on multi-purpose injection moulded test specimens prepared according to ISO 3167 and ISO 19069-2; and
the yield strength is in a range of from 22 to 35 MPa, determined according to ISO 527-1,-2:2012 on multi-purpose injection moulded test specimens prepared according to ISO 3167 and ISO 19069-2; and
the strain at break is in a range of from 9.0 to 30%, determined according to ISO 527-1,-2:2012 on multi-purpose injection moulded test specimens prepared according to ISO 3167 and ISO 19069-2; and
the Charpy notched impact strength is in a range of from 4.5 to 6.0 kJ/m², determined according to ISO 179-1:2010 at 23° C. on multi-purpose injection moulded test specimens prepared according to ISO 3167 and ISO 19069-2.

20: The controlled-rheology polypropylene composition (CR-PP) according to claim 1, wherein the mixed-plastics polypropylene based blend is present in the original polypropylene composition in an amount of from 40.0 to 99.99 wt %, based on the total weight of the original polypropylene composition.

21: The controlled-rheology polypropylene composition according to claim 10, wherein the piperazyl-ester derivative is a (1,2,2,6,6-pentaalkyl-4-piperidyl)ester derivative and the aromatic carbonyl component is an aromatic dicarbonyl component.
